(19) United States
(12) Patent Application Publication
(10) Pub. No.: US 2026/0049026 A1
(43) Pub. Date: Feb. 19, 2026

(54) COATED GLASS PANE SUITABLE FOR AN AUTOMOTIVE GLAZING

(71) Applicants: Shanghai Yaohua Pilkington Glass Group Co., Ltd., Shanghai (CN); SYP Kangqiao Autoglass Company Limited, Shanghai (CN); Pilkington Group Limited, Lathom (GB)

(72) Inventors: Matthew WERNER, Lathom (GB); John Andrew RIDEALGH, Lathom (GB)

(21) Appl. No.: 19/101,109

(22) PCT Filed: Aug. 4, 2023
(86) PCT No.: PCT/GB2023/052073

§ 371 Date: Feb. 4, 2025

(30) Foreign Application Priority Data
Aug. 5, 2022 (GB) 2211479.7

(51) Int. Cl. C03C 17/36; C03C 17/00

(52) U.S. Cl. CPC C03C 17/3639; C03C 17/002; C03C 17/3613; C03C 17/3626; C03C 17/3644; C03C 17/3668; C03C 2218/156

(57) ABSTRACT

A coated glass pane, in particular a coated glass pane suitable for an automotive glazing, has a coating sequence including comprising a multilayer superjacent coating in direct contact with a silver-based functional layer, wherein the multilayer superjacent coating includes a first superjacent layer and a second superjacent layer, the first superjacent layer is in direct contact with the silver-based functional layer and includes an oxide of zinc; and the second superjacent layer is in direct contact with the first superjacent layer and includes an oxide of zinc and tin. Also provided are a method of manufacturing the coated glass pane, a laminated glazing including the coated glass pane, and a method of manufacturing the laminated glazing.

The present invention relates to a coated glass pane, in particular a coated glass pane suitable for an automotive glazing. The invention also relates to a method of manufacturing said coated glass pane, a laminated glazing comprising the coated glass pane, and a method of manufacturing said laminated glazing.

There is a continual demand from the glass manufacturing industry for coated glass substrates which are able to meet the demanding performance requirements of automotive glazing. Such glazings must conform to the required standards of safety, be shaped to conform to the physical and aesthetic requirements of the structure in which they are placed and fulfil their primary function of light transmission. It is also desirable that such glazings are of a pleasant colour in terms of transmission and/or reflection.

In addition, vehicle glazings may comprise heating coatings for reducing condensation on the interior of the glazing and/or defrosting ice on the exterior of the glazing. Such heating coatings may comprise transparent conductive layers.

Glass coatings which comprise transparent conductive layers may be made up of repeat sequences of for example:
‘substrate/dielectric layer sequence/[silver (Ag) layer/dielectric layer sequence]ₙ’,
   with each of the layers not necessarily having the same thicknesses or composition as another. It is becoming more common in the glass manufacturing industry for ‘n’ in the sequence above to equal 2, 3, 4 or even 5 or more, allowing the production of coatings comprising 2, 3, 4, or even 5 or more silver layers. Such coatings may be deposited for example by physical vapour deposition processes, such as sputtering.

With increasing electrification of vehicles there remains a need to provide glazings with heating coatings which are suitable for hybrid or electric vehicles. Hybrid or electric vehicles may supply heating coatings with electrical supplies in low voltage ranges such as 12 or 14 V, medium voltages such as 48V, or even high voltages in excess of 100V. It is desirable to provide a heating coating that is able to perform effectively with a range of voltages, and in particular low voltage ranges.

In addition, in order to provide glazings meeting the required safety standards, glass panes are often submitted to thermal strengthening, in which the glass panes are heated to temperatures near or above the softening point of the glass, and then to rapidly cooled to impart stresses in the glass panes. Glass panes may be strengthened to provide varying degrees of stress, and therefore higher or lower strengths, as required.

Similarly, in order to provide glazings which conform to the required shape, glass panes are often submitted to thermal bending, in which the glass panes are heated to temperatures near or above the softening point of the glass, and then bent with the aid of suitable bending means.

In some cases, simultaneous bending and strengthening processes may be used. Such processes for altering the shape and/or properties of the glass pane using heat are known as “heat treatments”.

Many glazings comprise soda lime silica glass, which is often produced using a float process. The strengthening or bending of standard float glass of the soda lime silica type is typically achieved by heating the glass to temperatures in the region of 580 to 690° C., during which time the glass panes are kept at this temperature range for several minutes before initiating the actual toughening and/or bending process.

As such, the term “heat treatment”, in the following description and in the claims refers to thermal processes such as bending and/or thermal strengthening during which a coated glass pane reaches temperatures in the range of 580 to 690° C. for at least 5 minutes. A glass pane that has undergone such a treatment is referred to as “heat treated”.

Coated glass panes may also be submitted to strengthening and bending processes. However, coated glass panes are often incompatible with heat treatments, and may be damaged by the process. Typical damage to coated glass panes caused by heat treatments may be indicated by increased haze (often perceived as cloudiness), pinholes and spots. The function of the glazing may also be impaired, resulting in a decrease in light transmission and/or a reduction in the effectiveness of a low-emissivity coating, exemplified by an increase in sheet resistance values. As such, a coated glass pane that is damaged by heat treatment may be unacceptable due to its appearance and/or its reduced functional ability. A coated glass pane that exhibits such damage upon heat treatment is known as “non-heat treatable”. Conversely, a coated glass pane is deemed to be “heat treatable” if it survives a heat treatment without significant damage. A coated glass pane that exhibits damage upon heating may be “hazy”, which reduces clarity of view transmitted through the glazing to the observer. It is particularly desirable to provide low haze glazings for use as vehicle windscreens, as a high haze may interfere with driver vision, thereby increasing the risk of accidents.

Therefore, it is desirable to produce “heat treatable” coated glass panes.

The invention aims to provide heat treatable, and in particular bendable, coated glass panes suitable for lamination to provide a vehicle windscreen, which have a sufficiently high light transmittance to provide above 70% light transmission in the laminated vehicle windscreen, while also providing a resistivity such that the heating power per metre squared in the laminated windscreen is sufficiently high to provide effective demisting performance, which also has a reduced haze to improve vision through the glazing.

According to the first aspect of the present invention, there is provided a coated glass pane suitable for an automotive glazing, comprising a glass substrate and a coating sequence, wherein the coating sequence comprises, in order from the glass substrate:
a base layer in direct contact with the glass substrate;
a first subjacent coating;
a first silver-based functional layer in direct contact with the first subjacent coating;
a first superjacent coating in direct contact with the first silver-based functional layer;
a first intermediate dielectric coating;
a second subjacent coating;
a second silver-based functional layer in direct contact with the second subjacent coating;
a second superjacent coating in direct contact with the second silver-based functional layer; and
an upper dielectric coating, wherein:

the coating sequence comprises a multilayer superjacent coating in direct contact with a silver-based functional layer;
the multilayer superjacent coating comprises a first superjacent layer and a second superjacent layer;
the first superjacent layer is in direct contact with the silver-based functional layer and comprises an oxide of zinc; and
the second superjacent layer is in direct contact with the first superjacent layer and comprises an oxide of zinc and tin.

The inventors have appreciated that low voltage supply, such as 12 or 14V, necessitates a low resistivity heating coating to meet requirements for heating properties such as heating power per square metre (W/m²). The invention provides a heat treatable, and in particular bendable, coated glass pane suitable for lamination to provide a vehicle windscreen with above 70% light transmission and demisting performance, while improving haze. In particular, a low haze, low resistivity coated glass pane is provided with sheet resistances in the range 0.5 to less than 1.3 ohm/square.

### Silver-Based Functional Layers

The coating sequence comprises at least a first silver-based functional layer and a second silver-based functional layer. However, further silver-based functional layers with associated subjacent coatings, superjacent coatings and intermediate coatings are not excluded. Such additional silver-based functional layers may improve the conductivity of the coating.

As such, in some embodiments the coated glass pane further comprises between the second superjacent coating and the upper dielectric coating:
a second intermediate dielectric coating;
a third subjacent coating;
a third silver-based functional layer in direct contact with the third subjacent coating; and
a third superjacent coating in direct contact with the third silver-based functional layer.

In some embodiments the coated glass pane further comprises between the third superjacent coating and the upper dielectric coating:
a third intermediate dielectric coating;
a fourth subjacent coating;
a fourth silver-based functional layer in direct contact with the fourth subjacent coating; and
a fourth superjacent coating in direct contact with the fourth silver-based functional layer.

Glass panes comprising coating sequences with higher numbers of silver layers may increase the infra-red reflection capability of the glass pane. The skilled person will appreciate upon consultation of this specification that further sequences may be inserted to increase the number of silver-based functional layers, for example 5 or even more silver-based functional layers may be considered.

The silver-based functional layer(s) preferably consists essentially of silver without any additive, as is normally the case in the area of low-emissivity and/or solar control coatings. It is, however, within the scope of the invention to modify the properties of the silver-based functional layer(s) by adding doping agents, alloy additives or the like or even adding very thin metal or metal compound layers, as long as the properties of the silver-based functional layer(s) necessary to function as highly light-transmitting and low light-absorbent IR-reflective layer(s), are not substantially impaired thereby.

The thickness of each silver-based functional layer is dominated by its technical purpose. For typical low-emissivity and/or solar control purposes the preferred layer thickness for silver-based functional layers may preferably be from: 1 to 30 nm; more preferably from 5 to 20 nm; even more preferably from 8 to 18 nm; even more preferably from 10 to 16 nm. With such a layer thickness, light transmittance values of above 70% and a normal emissivity below 0.05 after a heat treatment may be readily achieved. Preferably, the first silver-based functional layer comprises a thickness of 3 nm to 20 nm, preferably each silver-based functional layer comprises a thickness of 3 nm to 20 nm, more preferably each silver-based functional layer comprises a thickness of 5 to 18 nm.

Preferably the coating sequence does not comprise a layer comprising nickel and chrome adjacent to a silver-based functional layer, more preferably the coating sequence does not comprise a layer comprising nickel and chrome.

Lower voltage supplies require lower resistance coatings to achieve the same heating power. Heating powers may be in the range 200 W/m² to 1000 W/m², with high heating powers within this range being preferred for “defrost” products, while lower heating powers within this range being preferred for “demist” products. Preferably, the heating power is between 300 and 600 W/m² for a demist product, which for a 14 V supply corresponds to a sheet resistance of from 0.5 ohm/square to less than 1.3 ohm per square.

The sheet resistance (Rs) is dependent upon the number and thickness of silver layers in the coating, a higher number of silver layers, or a greater thickness, will contribute to lower sheet resistance measurements. Preferably, the sheet resistance RS is less than 1.3 Ω/□.

### Superjacent Coatings

The coating sequence comprises a multilayer superjacent coating comprising a first superjacent layer and a second superjacent layer. Such superjacent coatings are preferably provided to protect the silver-based functional layer during deposition of subsequent layers, and prevent damage of the silver-based functional layer during a thermal treatment. At least a portion of the superjacent coating that is in direct contact with the silver-based functional layer is preferably deposited using non-reactive sputtering to avoid silver damage. It has been found that a superior protection of the silver-based functional layer during the deposition process and a high optical stability during a heat treatment may be achieved if the layer comprises a layer of a mixed metal oxide sputtered from a mixed metal oxide target.

Preferably the first superjacent layer comprises a thickness from 0.5 to 10 nm, preferably from 0.5 to 5 nm, more preferably from 0.5 to 3 nm, most preferably from 0.5 to 2 nm.

Preferably the second superjacent layer comprises a thickness from 0.5 to 20 nm, preferably from 0.5 to 10 nm, more preferably from 0.5 to 5 nm, more preferably from 0.5 to 3 nm, most preferably from 0.5 to 2 nm.

In some embodiments the first superjacent layer comprises a thickness from 0.5 to 3 nm and the second superjacent layer comprises a thickness from 0.5 to 3 nm. Such thicknesses provide excellent barrier properties and therefore reduce haze caused by a heat treatment step.

The coating sequence comprises at least one multilayer superjacent coating. However, further multilayer superjacent coatings are not excluded.

As such, in some embodiments each superjacent coating in direct contact with a silver-based functional layer comprises a multilayer superjacent coating in direct contact with a silver-based functional layer;
each multilayer superjacent coating comprises a first superjacent layer and a second superjacent layer;
each first superjacent layer is in direct contact with a silver-based functional layer and comprises an oxide of zinc; and
each second superjacent layer comprises an oxide of zinc and tin.

Preferably each first superjacent layer comprises a thickness from 0.5 to 10 nm, preferably from 0.5 to 5 nm, more preferably from 0.5 to 3 nm, most preferably from 0.5 to 2 nm.

Preferably, the first superjacent layer based on an oxide of zinc comprises a mixed metal oxide such as ZnO:Al. Good results are particularly achieved if a layer based on ZnO:Al is sputtered from a conductive ZnO:Al target. ZnO:Al may be deposited fully oxidized or such that it is slightly suboxidic.

The second superjacent layer comprises an oxide of zinc and tin. The second superjacent layer comprising an oxide of zinc and tin preferably comprises, in weight % of the total metal content of the layer: from 10 to 90 weight % zinc and from 90 to 10 weight % tin; more preferably from 40 to 60 weight % zinc and from 40 to 60 weight % tin; even more preferably around 50 weight % each of zinc and tin. In some preferred embodiments the layer comprising an oxide of zinc and tin comprises at most 18 weight % tin, more preferably at most 15 weight % tin, even more preferably at most 10 weight % tin. The layer comprising an oxide of zinc and tin is preferably deposited by reactive sputtering of a mixed ZnSn target in the presence of O₂.

In some embodiments each second superjacent layer comprises a thickness from 0.5 to 15 nm, preferably from 0.5 to 10 nm, more preferably from 0.5 to 5 nm, even more preferably from 0.5 to 2 nm. Alternatively each second superjacent layer between two silver-based functional layers comprises a thickness from 0.5 to 10 nm, preferably from 0.5 to 5 nm, more preferably from 0.5 to 3 nm, most preferably from 0.5 to 2 nm, and the uppermost superjacent layer comprises a thickness from 10 to 15 nm. Such an arrangement allows for a more robust coated glazing. Alternatively each second superjacent layer comprises a thickness from 10 to 15 nm.

Multilayer superjacent coatings preferably have a thickness less than or equal to 10 nm.

### Base Coating

The coated glass pane of the present invention comprises a base coating comprising a base layer in contact with the glass substrate.

Preferably the base layer comprises an oxide of zirconium and/or titanium or a nitride and/or oxide of silicon, preferably wherein the base layer comprises an oxide of zirconium and/or titanium or a nitride and/or oxide of silicon with a thickness from 5 to 100 nm, preferably from 10 to 50 nm, more preferably from 20 to 40 nm. Such thicknesses of such base layers allow for the production of coated glass panes that are particularly resistant to damage by heat treatment, while also providing improved pummel and optical performance.

Where the base layer comprises a nitride of silicon, it is preferred that the nitride of silicon is doped with aluminium. Doping with aluminium is preferably between 5 and 15 weight %, more preferably between 8 and 10 weight %. Such base layers allow for the production of coated glass panes that are particularly resistant to damage by heat treatment.

Preferably, the base layer comprising an oxide of zirconium and titanium comprises ZrₓTi_{y}O_{z} and the atomic proportion of Zr based on Zr and Ti in the base layer, calculated as x/(x+y), is from 0.40 to 0.95.

As used herein, the atomic proportion of zirconium (Zr) based on zirconium and titanium (Ti), calculated as x/(x+y), is calculated by dividing the atomic % of zirconium in the total composition by the sum of the atomic percentages of zirconium and titanium in the total composition. For example, a layer with atomic percentages Zr (20), Ti (20), O (60) has an atomic proportion of Zr of 0.5. Preferably, the atomic proportion of Zr based on Zr and Ti in the base layer, calculated as x/(x+y), is from 0.50 to 0.90. Preferably, the atomic proportion of Zr based on Zr and Ti in the base layer, calculated as x/(x+y) is from 0.55 to 0.85. More preferably the atomic proportion of Zr based on Zr and Ti in the base layer, calculated as x/(x+y), is from 0.60 to 0.80. Yet more preferably the atomic proportion of Zr based on Zr and Ti in the base layer, calculated as x/(x+y), is from 0.62 to 0.67. Coated glass panes comprising base layers with such atomic proportions of Zr have particularly good heat treatment performance.

Preferably, the atomic % of titanium in the base layer, calculated as Ti in the total composition, is from 1 to 25, preferably from 5 to 20, more preferably from 8 to 15.

Preferably, the atomic % of oxygen in the base layer, calculated as O in the total composition, is from 60 to 70, preferably from 62 to 66, more preferably from 63 to 65.

Preferably the atomic % of zirconium in the base layer, calculated as Zr in the total composition, is from 12 to 35, preferably from 15 to 25.

The base coating may comprise further layers between the base layer and the first subjacent coating. For example, the base coating may comprise a layer comprising an oxide of zinc and tin between the base layer and the first subjacent coating. Such a layer comprising an oxide of zinc and tin in the base coating may improve the optical properties of the coated glass pane and stability to heat treatment.

When the base coating comprises a layer comprising an oxide of zinc and tin, the layer comprising an oxide of zinc and tin preferably comprises, in weight % of the total metal content of the layer: from 10 to 90 weight % zinc and from 90 to 10 weight % tin; more preferably from 40 to 60 weight % zinc and from 40 to 60 weight % tin; even more preferably around 50 weight % each of zinc and tin. In some preferred embodiments the layer comprising an oxide of zinc and tin comprises at most 18 weight % tin, more preferably at most 15 weight % tin, even more preferably at most 10 weight % tin. The layer comprising an oxide of zinc and tin is preferably deposited by reactive sputtering of a mixed ZnSn target in the presence of O₂.

The layer comprising an oxide of zinc and tin preferably has a thickness of at least 10 nm. More preferably, the layer comprising an oxide of zinc and tin has a thickness of from 10 nm to 20 nm. Even more preferably, the layer comprising an oxide of zinc and tin has a thickness of from 12 nm to 16 nm. Most preferably, the layer comprising an oxide of zinc and tin has a thickness of from 12 nm to 14 nm.

### Subjacent Coating

The coating sequence comprises subjacent coatings adjacent and below silver-based functional layers. A subjacent coating does not comprise the base coating, or intermediate coatings, below it. It is desirable that the subjacent coatings provide a well orientated crystal structure for the subsequent growth of the silver-based functional layer, thereby improving its conductivity.

Any or all of the subjacent coatings may preferably have a thickness of at least 2 nm. More preferably, any or all of the subjacent coatings may preferably have a thickness of from 2 to 20 nm; or from 3 to 12 nm. Even more preferably any or all of the subjacent coatings may preferably have a thickness of from 12 to 18 nm. Most preferably the any or all of the subjacent coatings has a thickness of from 15 to 17 nm.

Preferably the first subjacent coating comprises a layer comprising an oxide of zinc in direct contact with an overlying silver-based functional layer, preferably each subjacent coating comprises a layer comprising an oxide of zinc in direct contact with an overlying silver-based functional layer.

Preferably, the first subjacent coating and/or the second subjacent coating and/or the third subjacent coating and/or the fourth subjacent coating, where present, comprise a layer comprising an oxide of zinc, preferably an oxide of zinc doped with aluminium. Such layers allow the deposition of silver-based functional layers which have improved conductivity. Where a subjacent coating comprises a layer comprising an oxide of zinc doped with aluminium such doping is up to about 10 weight %. A typical content of aluminium is about 2 weight %.

It is preferred that a layer comprising an oxide of zinc of the subjacent coating directly adjacent to the silver-based functional layer are reactively sputtered from a zinc target in an atmosphere comprising oxygen (O₂), or deposited by sputtering from a ceramic target, for example based on zinc oxide and optionally doped with aluminium, in an atmosphere containing zero or only a small amount, that is, generally no more than about 5 volume %, of oxygen.

### Intermediate Dielectric Coatings

The coated glass pane according to the present invention comprises a first intermediate dielectric coating, and may comprise further intermediate dielectric coatings.

Preferably, such intermediate dielectric coatings comprise a layer comprising an oxide of zinc of thickness greater than 10 nm, preferably a layer comprising an oxide of zinc doped with aluminium of thickness greater than 10 nm. Preferably, the layer comprising an oxide of zinc doped with aluminium comprises between 1 and 15% aluminium by weight.

In some cases, intermediate dielectric layers may comprise a layer comprising an oxide of zirconium and titanium ZrₓTi_{y}O_{z}. In some embodiments, the layer comprising an oxide of zirconium and titanium ZrₓTi_{y}O_{z} of an intermediate dielectric layer may comprise an atomic proportion of Zr based on Zr and Ti, calculated as x/(x+y), from 0.40 to 0.95.

Preferably an intermediate dielectric coating comprises a first intermediate layer comprising an oxide of zinc and a second intermediate layer comprising a nitride of silicon and/or aluminium, preferably each intermediate dielectric coating comprises a first intermediate layer comprising an oxide of zinc and a second intermediate layer comprising a nitride of silicon and/or aluminium.

Preferably the first intermediate layer comprising an oxide of zinc comprises a thickness of from 10 to 20 nm, preferably each first intermediate layer comprising an oxide of zinc comprises a thickness of from 10 to 20 nm.

Preferably the second intermediate layer comprising a nitride of silicon and/or aluminium comprises a thickness of from 30 to 60 nm, preferably each second intermediate layer comprising a nitride of silicon and/or aluminium comprises a thickness of from 30 to 60 nm.

### Upper Dielectric Coating

The coating sequence comprises an upper dielectric coating. The upper dielectric coating does not comprise the superjacent layer below it.

Preferably, the upper dielectric coating comprises in sequence from the glass substrate a layer comprising a layer comprising a nitride of silicon and/or aluminium, and an outermost layer.

Layers comprising an oxide of zinc and tin in the upper dielectric coating may preferably have a thickness of from 0.5 to 20 nm, more preferably from 1 to 10 nm, even more preferably from 1.5 to 3 nm. These preferred thicknesses enable further ease of deposition and improvement in optical characteristics such as haze whilst retaining mechanical durability.

Layers in the upper dielectric coating based on an (oxi)nitride of aluminium or an (oxi)nitride of silicon may preferably comprise a thickness of at least 5 nm; preferably from 20 to 40 nm. Such thicknesses provide further improvement in terms of mechanical robustness of the coated pane. Said layer based on an (oxi)nitride of aluminium, an (oxi)nitride of silicon, may preferably be in direct contact with a layer comprising on an oxide of zinc (Zn) in the upper dielectric layer.

Layers based on an (oxi)nitride of aluminium, and/or an (oxi)nitride of silicon, may comprise a major part of the upper dielectric coating and provide stability (better protection during heat treatments) and diffusion barrier properties. Said layer is preferably deposited as an Al nitride and/or Si nitride layer by reactive sputtering of a Si, Al or mixed SiAl target, for example, of a Si₉₀Al₁₀ target in a N₂ containing atmosphere. The composition of the layer based on an (oxi)nitride of aluminium and/or an (oxi)nitride of silicon may be essentially stoichiometric Si₉₀Al₁₀Nₓ.

Preferably oxide layers in the upper dielectric coating are based on essentially stoichiometric metal oxides. The use of layers based on essentially stoichiometric metal oxides rather than metallic or less than 95% stoichiometric layers leads to an extremely high optical stability of the coating during a heat treatment and effectively assists in keeping optical modifications during heat treatment small. Additionally, the use of layers based on essentially stoichiometric metal oxides provides benefits in terms of mechanical robustness.

In some cases, the upper dielectric coating may comprise a layer comprising an oxide of zirconium and titanium ZrₓTi_{y}O_{z}. In some embodiments, the layer comprising an oxide of zirconium and titanium ZrₓTi_{y}O_{z} of the upper dielectric may comprise an atomic proportion of Zr based on Zr and Ti, calculated as x/(x+y), from 0.40 to 0.95.

Preferably, the upper dielectric coating comprises an outermost layer comprising an oxide of zirconium, an oxide of silicon and/or aluminium, an oxide of zinc and tin, or a nitride of silicon and/or aluminium. Such layers may increase the pummel performance of coated glass panes when incorporated into a laminated glazing.

The outermost layer is preferably a protective layer that is the outermost layer of the coating, for increased mechanical and/or chemical robustness, for example scratch resistance. In some embodiments, the outermost layer comprises a layer based on an oxide of zinc and tin. In addition to zinc and tin, the protection layer may contain zirconium. Preferably, an outermost layer based on an oxide of zinc, tin and zirconium comprises from 12 to 35 atomic % zirconium. More preferably, the outermost layer based on an oxide of zinc, tin and zirconium comprises from 15 to 33 atomic % zirconium. Most preferably, the outermost layer based on an oxide of zinc, tin and zirconium comprises from 18 to 33 atomic % zirconium.

Preferably, the heat treatable coated glass pane, upon heat treatment, provides a heat-treated coated glass pane with a hazescan value of less than 90, more preferably less than 60, yet more preferably less than 50.

In some embodiments the heat treated coated glass pane exhibits a hazescan value of less than 90. Preferably the hazescan value is less than 80 and even more preferably less than 70 is desirable. In some applications, where clarity is prioritised, a hazescan value of less than 60 is desired, and preferably less than 50.

Preferably, the substrate is soda-lime silica glass sheet. Soda-lime silica glass sheets are particularly well suited to bending operations. Preferably, the substrate is soda-lime silica glass sheet of thickness less than or equal to 3.5 mm. More preferably, the substrate is soda-lime silica glass sheet of thickness less than or equal to 2.5 mm. Such thicknesses of soda-lime silica glass sheets are particularly well suited to bending and/or lamination operations.

In some embodiments, the coated glass pane is a heat treated coated glass pane. Preferably, the heat treated coated glass pane is a thermally bent coated glass pane or a thermally strengthened coated glass pane.

Coated glass panes that have undergone thermal bending comprise a radius of curvature in at least one direction, preferably coated glass panes that have undergone thermal bending comprise a radius of curvature in at least one direction of from 500 mm to 20000 mm, more preferably coated glass panes that have undergone thermal bending comprise a radius of curvature in at least one direction of from 1000 mm to 8000 mm.

Coated glass panes that have undergone thermal toughening are preferably at least twice as strong as annealed glass of a similar thickness. Coated glass panes that have undergone thermal toughening are preferably at least four times as strong as annealed glass of a similar thickness. Preferably, the thermally strengthened heat treated coated glass pane comprises a compressive stress on the surface of from 400 to 1500 kg/m². Where the thermally strengthened heat treated coated glass pane comprises a toughened glass pane, preferably the coated glass pane comprises a compressive stress on the surface of from 750 to 1500 kg/m². Alternatively, the thermally strengthened heat treated coated glass pane may comprise a compressive stress on the surface of from 400 to 700 kg/m²—such panes are known in the art as “heat strengthened” rather than “toughened”.

Glass panes that have undergone thermal strengthening are regulated by standards such as EN12600, BS 6206:1981 and others. Preferably, the thermally strengthened coated glass pane achieves Class 1 to EN 12600. Preferably, the thermally toughened coated glass pane achieves class 1 to EN 12600 with a mode of breakage type C. More preferably, the thermally toughened coated glass pane achieves class 1(C)1 to EN 12600. Preferably, the thermally toughened coated glass pane conforms to BS 6206:1981 Class C, more preferably Class B, yet more preferably Class A.

Glazings may be categorised according to their resistance against manual attack according to EN356. Preferably, the thermally toughened coated glass pane conforms to at least P1A and/or P6B according to EN356.

Preferably, glass panes that have undergone thermal toughening have been submitted to a heat soaking process.

It will be appreciated that coating sequences according to the present invention may include further coating layers, and that any further layer may contain additives that modify its properties and/or facilitate its manufacture, for example, doping agents or reaction products of reactive sputtering gases. In the case of oxide based layers, nitrogen may be added to the sputtering atmosphere leading to the formation of oxinitrides rather than oxides, in the case of nitride based layers oxygen may be added to the sputtering atmosphere, also leading to the formation of oxinitrides rather than nitrides.

Care must be taken by performing a proper material, structure and thickness selection when adding any such further partial layer to the basic layer sequence of the inventive pane that the properties primarily aimed at, for example, a high thermal stability, are not significantly impaired thereby.

Also, in the context of the present invention, where a layer is said to be “based on” a particular material or materials this means, unless stated otherwise, that the layer predominantly comprises said material or materials in an amount of at least 50 atomic %, i.e. a layer based on ZnOₓ:Al should have a sum of atomic percentages of Zn, O, and Al greater than 50%.

Where a layer is based on ZnSnOₓ, “ZnSnOₓ” means an oxide of Zn and Sn as described and defined elsewhere in the description. Preferably the oxide of zinc and tin has an weight ratio of metals Zn:Sn of 1:1. Alternatively, the oxide of zinc and tin may comprise a weight ratio of metals Zn:Sn of from 0.1:1 to 1:0.1.

In some embodiments the coating sequence is deleted around the periphery of the coated glass pane. Such “edge deletion” results in the absence of coating around the periphery of the coated glass pane, to prevent electrification of items adjoined to the coated pane when the coating sequence is electrified. Such edge deletion may be accomplished for example by abrasion, laser, etching and/or masking the pane prior to a coating step.

According to a second aspect of the present invention, there is provided a method of manufacturing a coated glass pane according to the first aspect, comprising the steps of:
i) providing a glass substrate; and
ii) sequentially coating the glass substrate with coating layers by sputtering.

Preferably, the method further comprises, after step ii), the step of:
iii) heat treating the glass substrate,
   preferably wherein heat treating the glass substrate comprises bending or toughening.

In relation to the second aspect of the present invention it will be appreciated that all features of the first aspect of the present invention, such as the glass substrate, the base layer, the upper dielectric layer, and the silver-based functional layer, may also be applied to the second aspect of the present invention in any combination.

The invention is not limited to a specific production process for the coating. However, it is particularly preferred if at least one of the layers and most preferably all layers are applied by magnetron cathode sputtering, either in the DC mode, in the pulsed mode, in the medium frequency mode or in any other suitable mode, whereby metallic or ceramic targets are sputtered reactively or non-reactively in a suitable sputtering atmosphere. Depending on the materials to be sputtered, planar or rotating tubular targets may be used.

Preferably, the base coating, and/or the silver-based functional layer, and/or the upper dielectric coating, and/or an intermediate dielectric coating are provided by physical vapour deposition.

In the context of the present invention the term “non-reactive sputtering” includes sputtering an oxidic target in a low oxygen atmosphere (that is with zero, or up to 10% volume oxygen) to provide an essentially stoichiometric oxide.

In some embodiments, the base layer is produced using reactive sputtering from a TiZr metallic target in Ar/O₂ atmosphere. Alternatively, the base layer is produced by co-sputtering a titanium metallic target and a zirconium metallic target in Ar/O₂ atmosphere. Alternatively, the base layer is produced by sputtering from a TiₓZr_{y}Oₓ ceramic target in an atmosphere with less than 10% oxygen.

Layers based on an oxide of Zn, Ti, ZnSn, InSn, Zr, Al, Sn and/or Si, and/or an (oxi)nitride of Si and/or of Al, may be deposited by non-reactive sputtering. Said layers may be sputtered from ceramic targets.

Layers based on an oxide of Zn, Ti, ZnSn, InSn, Zr, Al, Sn and/or Si, and/or an (oxi)nitride of Si and/or of Al, may also be deposited by reactive sputtering. Said layers may be sputtered from one or more metal targets.

Layers may be provided to their total final thickness in a single coating pass. Alternatively, multiple coating passes using the same coating chemistry may be used to provide a single layer of final thickness. As used herein, sublayers of substantially the same composition provided by multiple passes are considered together as being a single layer with a thickness equal to the sum of the thicknesses of the sublayers.

To minimize any light absorption in the coating and to reduce the light transmittance increase during heat treatment where this is not desired, all individual layers of the upper and lower dielectric coatings are preferably deposited with an essentially stoichiometric composition. In particular, the coating process is preferably carried out by setting up suitable coating conditions such that any oxygen (or nitrogen) deficit of any oxide (or nitride) layer of the coating is kept low, to achieve a high stability of the light transmittance and colour of the coated glass panes during heat treatment.

Light transmittance values referred to in the specification are generally specified with reference to a coated glass pane comprising a 4 mm thick standard float glass pane having a light transmittance TL in the region of 90% without a coating.

According to a third aspect of the present invention there is provided a laminated glazing, preferably a windscreen, comprising a coated glass pane according to the first aspect of the invention, a further glass pane, and an interlayer between the coated glass pane and the further glass pane.

Preferably the substrate and the further glass pane each have a thickness less than 2.5 mm, preferably less than or equal to 2.1 mm, and the interlayer comprises a sheet of polyvinyl butyral (PVB).

According to a fourth aspect of the present invention there is provided a method of manufacturing a laminated glazing according to the third aspect of the invention, comprising the steps of:
i) providing an arrangement comprising a coated glass pane according to the first aspect of the invention, a further glass pane, and an interlayer between the coated glass pane and the further glass pane; and
ii) submitting the arrangement to a lamination process, preferably in an autoclave.

According to a fifth aspect of the present invention, there is provided a vehicle glazing comprising a laminated glazing according to the third aspect of the present invention.

Preferably, the vehicle glazing further comprises busbars and/or connectors for supplying electrical energy to the coating sequence. The skilled person is aware of such connectors and busbars. The connectors may be soldered to the busbars, preferably with lead-free solder.

Optional or advantageous features of the first aspect of the present invention may be combined with the second, third, fourth and fifth aspects of the present invention in any combination.

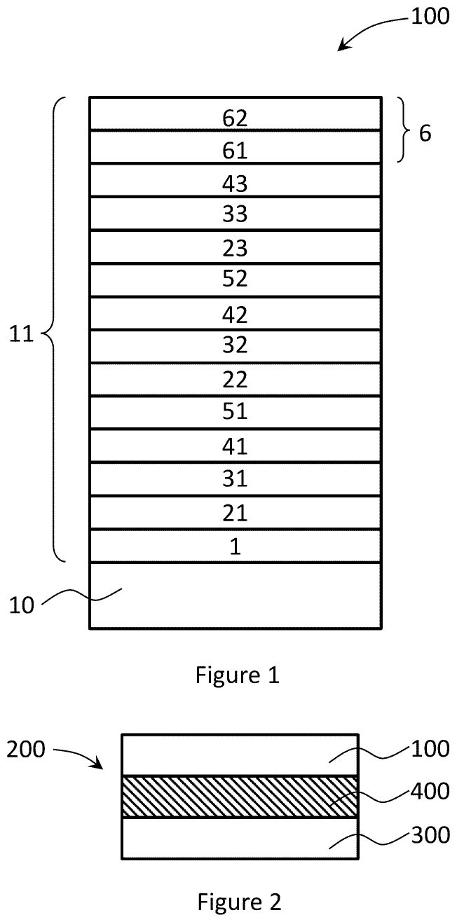

Embodiments of the present invention will now be described herein, by way of the non-limiting examples and with reference to FIGS. 1 to 2.

FIG. 1 illustrates a schematic cross-sectional view of a coated glass pane according to a first embodiment of the present invention.

FIG. 2 illustrates a schematic cross-sectional view of a laminated glazing according to a third aspect. coated glass pane according to a second embodiment of the present invention.

FIG. 1 depicts a coated glass pane 100 suitable for an automotive glazing, comprising a glass substrate 10 and a coating sequence 11, wherein the coating sequence 11 comprises, in order from the glass substrate 10:
a base layer 1 in direct contact with the glass substrate 10;
a first subjacent coating 21;
a first silver-based functional layer 31 in direct contact with the first subjacent coating 21;
a first superjacent coating 41 in direct contact with the first silver-based functional layer 31;
a first intermediate dielectric coating 51;
a second subjacent coating 22;
a second silver-based functional layer 32 in direct contact with the second subjacent coating 22;
a second superjacent coating 42 in direct contact with the second silver-based functional layer 32; and
an upper dielectric coating 6, wherein:
the coating sequence comprises a multilayer superjacent coating 41 in direct contact with the first silver-based functional layer 31;
the multilayer superjacent coating 41 comprises a first superjacent layer and a second superjacent layer;
the first superjacent layer is in direct contact with the first silver-based functional layer 31 and comprises an oxide of zinc; and
the second superjacent layer is in direct contact with the first superjacent layer comprises an oxide of zinc and tin.

In this embodiment, the coating sequence 11 further comprises:
a second intermediate dielectric coating 52;
a third subjacent coating 23;
a third silver-based functional layer 33 in direct contact with the second subjacent coating 23;
a third superjacent coating 43 in direct contact with the third silver-based functional layer 33, and the upper dielectric coating 6 comprises a first layer 61, and an outermost layer 62.

The skilled person will appreciate that while in this embodiment the first superjacent layer is a multilayer superjacent layer and the second superjacent layer is not a multilayer superjacent layer, alternative embodiments may be provided wherein:
the first superjacent layer is a multilayer superjacent layer and the second superjacent layer is a multilayer superjacent layer and the third superjacent layer is a multilayer superjacent layer; or the first superjacent layer is not a multilayer superjacent layer and the second superjacent layer is a multilayer superjacent layer and the third superjacent layer is a multilayer superjacent layer; or
the first superjacent layer is not a multilayer superjacent layer and the second superjacent layer is not a multilayer superjacent layer and the third superjacent layer is a multilayer superjacent layer; or
the first superjacent layer is not a multilayer superjacent layer and the second superjacent layer is a multilayer superjacent layer and the third superjacent layer is not a multilayer superjacent layer, among other alternative combinations.

FIG. 2 depicts a laminated glazing 200 according to a second embodiment of the present invention, comprising a coated glass pane 100, a second glass pane 300, and an interlayer 400 therebetween.

Example embodiments of the present invention will now be described herein, by way of example only.

For all examples the coatings were deposited on 4 mm thick standard float glass panes with a light transmittance in the region of 90% using AC and/or DC magnetron (or pulsed DC) sputtering devices, medium-frequency sputtering being applied where appropriate.

Layers comprising an oxide of zirconium and titanium may be reactively co-sputtered from a first target of titanium metal and a second target of zirconium metal in an argon/oxygen (Ar/O₂) sputter atmosphere.

Layers comprising an oxide of zinc and tin were reactively sputtered from zinc-tin targets (weight ratio of metals Zn:Sn approximately 50:50) in an argon/oxygen (Ar/O₂) sputter atmosphere.

Layers comprising an oxide of zinc (Zn), tin (Sn) and zirconium (Zr) were co-sputtered using metallic ZnSn (weight ratio Zn:Sn approximately 50:50) and Zr targets in an Ar/O₂ or pure argon (Ar) atmosphere.

Layers comprising an oxide of zinc doped with aluminium (ZnO:Al) were sputtered from Al-doped Zn targets (aluminium (Al) content about 2 weight %) in an Ar/O₂ sputter atmosphere.

The functional layers that in all examples consisted of essentially pure silver (Ag) were sputtered from silver targets in an Ar sputter atmosphere without any added oxygen and at a partial pressure of residual oxygen below 10-5 mbar.

Layers comprising an oxide of zinc doped with aluminium directly adjacent to silver-based functional layers were sputtered from conductive ZnOₓ:Al targets comprising 2% AlOₓ by weight in a pure Argon (Ar) sputter atmosphere with less than 5% oxygen.

Table 1 provides details of a coated glass panes according to the present invention. Layer thicknesses in examples 1B and 2B are modified to maintain optical properties when NiCrOx layers are provided in place of a ZnO:Al/ZnSnOx multilayers of examples 1A and 2A. Examples 1A and 1B have a zirconium oxide outer layer.

TABLE 1

| Example 1A | Example 1B | Example 2A | Example 2B |
|---|---|---|---|
| Glass | Glass | Glass | Glass |
| SiNx (30) | SiNx (30) | SiNx (30) | SiNx (30) |
| ZnO:Al (16.4) | ZnO:Al (16.4) | ZnO:Al (16.4) | ZnO:Al (16.4) |
| Ag (15.1) | Ag (15.1) | Ag (15.1) | Ag (15.1) |
| ZnO:Al (2) | NiCrOx (0.4) | ZnO:Al (2) | NiCrOx (0.4) |
| ZnSnOx (2) | | ZnSnOx (2) | |
| ZnO:Al (12.5) | ZnO:Al (14.9) | ZnO:Al (12.5) | ZnO:Al (14.9) |
| SiNx (46.8) | SiNx (46.8) | SiNx (46.8) | SiNx (46.8) |
| ZnO:Al (15.9) | ZnO:Al (15.9) | ZnO:Al (15.9) | ZnO:Al (15.9) |
| Ag (15.7) | Ag (15.7) | Ag (15.7) | Ag (15.7) |
| ZnO:Al (2) | NiCrOx (0.4) | ZnO:Al (2) | NiCrOx (0.4) |
| ZnSnOx (2) | | ZnSnOx (2) | |
| ZnO:Al (10.4) | ZnO:Al (12.8) | ZnO:Al (10.4) | ZnO:Al (12.8) |
| SiNx (48.9) | SiNx (48.9) | SiNx (48.9) | SiNx (48.9) |
| ZnO:Al (15.9) | ZnO:Al (15.9) | ZnO:Al (15.9) | ZnO:Al (15.9) |
| Ag (13.8) | Ag (13.8) | Ag (13.8) | Ag (13.8) |
| ZnO:Al (2) | NiCrOx (0.4) | ZnO:Al (2) | NiCrOx (0.4) |
| ZnSnOx (2) | | ZnSnOx (2) | |
| ZnO:Al (11.2) | ZnO:Al (13.8) | ZnO:Al (11.2) | ZnO:Al (13.6) |
| SiNx (20.6) | SiNx (20.6) | SiNx (26.6) | SiNx (26.6) |
| ZrO2 (6) | ZrO2 (6) | | |

After coating deposition the samples were heat treated in the region of 650° C. for 5 minutes. Thereafter, Hazescan, sheet resistance (Rs HT) and light transmission (TL % HT) were measured. Table 2 provides measured properties of the example coated glass panes.

TABLE 2

| | Example 1A | Example 1B | Example 2A | Example 2B |
|---|---|---|---|---|
| Hazescan | 59 | 102 | 45 | 97 |
| Rs HT | 1.13 | 0.96 | 1.24 | 0.98 |
| TL % HT | 75.9 | 75.9 | 75.0 | 75.7 |

From table 2 it can be seen that examples 1B and 2B have levels of hazescan which may provide extremely high visual haze to the observer, which is undesirable when used in a vehicle glazing, and in particular a windscreen. The removal of NiCrOx layers and replacement with a multilayer superjacent coating results in greatly improved hazescan, while maintaining similar light transmission and sheet resistance. This indicates that a heated vehicle glazing comprising a coated pane according to example 1A or 2A would have greatly improved visual clarity compared to examples 1B or 2B, while still providing acceptable demist performance.

The methodology used to collect the data in Table 2 is set out below.

Light Transmittance—The values stated for the percentage (%) light transmittance upon heat treatment of the coated glass panes were derived from measurements using illuminant D65, for a 10 degree observer field of view across wavelengths ranging from 350-1050 nm.

Sheet Resistance/Change in sheet resistance for examples—Sheet resistance measurements were made using a NAGY SRM-12. This device utilises an inductor to generate eddy currents in a 100 mm×100 mm coated sample. This produces a measurable magnetic field, the magnitude of which is related to the resistivity of the sample. With this method the sheet resistance can be calculated. The instrument was used to measure the sheet resistance of samples before and after heat treatment at 650° C. for 5 minutes.

Hazescan—A haze scoring system was applied to each of the examples and comparative examples, wherein the haze was measured following heat treatment. The quality assessment evaluation system described hereinafter was also used to more clearly distinguish the visual quality of coatings under bright light conditions; properties that are not fully reflected by standard haze values measured in accordance with ASTM D 1003.

The evaluation system considers the more macroscopic effect of visible faults in the coating which cause local colour variations where the coating is damaged or imperfect (hazescan in Table 1). This assessment analyses the light levels in images of heat treated samples taken using fixed lighting conditions and geometries.

To generate the images used to calculate hazescan values, samples are placed inside a black box, 30 cm away from the camera lens. Samples are illuminated using a standard 1200 lumen light with a brightness between 2400 and 2800 Lux, as measured at the samples position. The sample is then photographed using a standard aperture size and exposure length of f5.6 and 1 second with focal length of 105 mm and ISO 400. The greyscale of each pixel in the resulting image is then recorded, with a value of 0 representing black and 255 representing white. Statistical analysis of these values is undertaken to give an overall assessment of the haze of the sample, referred to herein as the hazescan value. The lower the hazescan value recorded, the more superior the results. In general, a hazescan value of less than 90, preferably less than 80 and even more preferably less than 70 is desirable. In some specialist applications, where clarity is prioritised, a hazescan value of less than 60 is desired.

Surprisingly, coatings according to the present invention exhibit parameters which indicate that they are suitable for applications where toughened panes are required. In particular, hazescan of the examples according to present invention measured following heat treatment was remarkably low, in some cases less than 50.

1.-25. (canceled)

26. A coated glass pane suitable for an automotive glazing, comprising a glass substrate and a coating sequence, wherein the coating sequence comprises, in order from the glass substrate:
a base coating comprising a base layer in direct contact with the glass substrate;
a first subjacent coating;
a first silver-based functional layer in direct contact with the first subjacent coating;
a first superjacent coating in direct contact with the first silver-based functional layer;
a first intermediate dielectric coating;
a second subjacent coating;
a second silver-based functional layer in direct contact with the second subjacent coating;
a second superjacent coating in direct contact with the second silver-based functional layer; and
an upper dielectric coating, wherein:
the coating sequence comprises a multilayer superjacent coating in direct contact with a silver-based functional layer;
the multilayer superjacent coating comprises a first superjacent layer and a second superjacent layer;
the first superjacent layer is in direct contact with the silver-based functional layer and comprises an oxide of zinc; and
the second superjacent layer is in direct contact with the first superjacent layer and comprises an oxide of zinc and tin.

27. The coated glass pane according to claim 26, wherein the first superjacent layer comprises a thickness from 0.5 to 10 nm and/or wherein the second superjacent layer comprises a thickness from 0.5 to 20 nm.

28. The coated glass pane according to claim 26, further comprising between the second superjacent coating and the upper dielectric coating:
a second intermediate dielectric coating;
a third subjacent coating;
a third silver-based functional layer in direct contact with the third subjacent coating; and
a third superjacent coating in direct contact with the third silver-based functional layer.

29. The coated glass pane according to claim 28, further comprising, between the third superjacent coating and the upper dielectric coating:
a third intermediate dielectric coating;
a fourth subjacent coating;
a fourth silver-based functional layer in direct contact with the fourth subjacent coating; and
a fourth superjacent coating in direct contact with the fourth silver-based functional layer.

30. The coated glass pane according to claim 26, wherein each superjacent coating in direct contact with a silver-based functional layer comprises a multilayer superjacent coating in direct contact with a silver-based functional layer; each multilayer superjacent coating comprises a first superjacent layer and a second superjacent layer; each first superjacent layer is in direct contact with a silver-based functional layer and comprises an oxide of zinc; and each second superjacent layer comprises an oxide of zinc and tin.

31. The coated glass pane according to claim 30, wherein each first superjacent layer comprises a thickness from 0.5 to 10 nm and/or wherein each second superjacent layer comprises a thickness from 0.5 to 20 nm and/or wherein each second superjacent layer between two silver-based functional layers comprises a thickness from 0.5 to 10 nm.

32. The coated glass pane according to claim 26, wherein the base layer comprises an oxide of zirconium and/or titanium or a nitride and/or oxide of silicon.

33. The coated glass pane according to claim 26, wherein the first subjacent coating comprises a layer comprising an oxide of zinc in direct contact with an overlying silver-based functional layer, optionally wherein each subjacent coating comprises a layer comprising an oxide of zinc in direct contact with an overlying silver-based functional layer.

34. The coated glass pane according to claim 26, wherein the coating sequence does not comprise a layer comprising nickel and chrome adjacent to a silver-based functional layer, optionally wherein the coating sequence does not comprise a layer comprising nickel and chrome.

35. The coated glass pane according to claim 26, wherein an intermediate dielectric coating comprises a first intermediate layer comprising an oxide of zinc in direct contact with a multilayer superjacent coating upon a silver-based functional coating, optionally wherein each intermediate dielectric coating comprises a first intermediate layer comprising an oxide of zinc in direct contact with a multilayer superjacent coating upon a silver-based functional coating.

36. The coated glass pane according to claim 26, wherein an intermediate dielectric coating comprises a first intermediate layer comprising a thickness of from 10 to 20 nm in direct contact with a multilayer superjacent coating upon a silver-based functional coating, optionally wherein each intermediate dielectric coating comprises a first intermediate layer comprising a thickness of from 10 to 20 nm in direct contact with a multilayer superjacent coating upon a silver-based functional coating.

37. The coated glass pane according to claim 35, wherein the intermediate dielectric coating comprises a second intermediate layer comprising a nitride of silicon and/or aluminium comprising a thickness of from 30 to 60 nm, optionally wherein each intermediate dielectric coating comprises a second intermediate layer comprising a nitride of silicon and/or aluminium comprising a thickness of from 30 to 60 nm.

38. The coated glass pane according to claim 26, wherein the upper dielectric coating comprises in sequence from the glass substrate a layer comprising a layer comprising a nitride of silicon and/or aluminium, and an outermost layer.

39. The coated glass pane according to claim 26, wherein the upper dielectric coating comprises an outermost layer comprising an oxide of zirconium, an oxide of silicon and/or aluminium, an oxide of zinc and tin, or a nitride of silicon and/or aluminium.

40. The coated glass pane according to claim 26, wherein the coating sequence is deleted around the periphery of the coated glass pane.

41. A method of manufacturing a coated glass pane according to claim 26, comprising the steps of:
i) providing a glass substrate; and
ii) sequentially coating the glass substrate with coating layers by sputtering.

42. The method of manufacturing a coated glass pane according to claim 41, further comprising, after step ii) the step of:
iii) heat treating the glass substrate,
optionally wherein heat treating the glass substrate comprises bending or toughening.

43. A laminated glazing, optionally a windscreen, comprising a coated glass pane according to claim 26, a further glass pane, and an interlayer between the coated glass pane and the further glass pane.

44. A method of manufacturing a laminated glazing, comprising the steps of:
i) providing an arrangement comprising a coated glass pane according to claim 26, a further glass pane, and an interlayer between the coated glass pane and the further glass pane; and
ii) submitting the arrangement to a lamination process, optionally in an autoclave.

45. A vehicle glazing comprising a laminated glazing according to claim 43, further comprising busbars and/or connectors for supplying electrical energy to the coating sequence.
